(19) United States
(12) Patent Application Publication
(10) Pub. No.: US 2018/0079128 A1
(43) Pub. Date: Mar. 22, 2018

(54) METHODS, ASSEMBLIES, SYSTEMS, AND INTERMEDIATE STAGE PRE-ASSEMBLY MULTI-CHAMBER CONTAINERS TO MAKE A MULTI-CHAMBER CONTAINER

(71) Applicant: Graham Packaging Company, L.P., Lancaster, PA (US)

(72) Inventors: Gilles J. Rapet, Vertrieu (FR); Armel A. Archeny, Bouvesse-Quirieu (FR); Gregory Antier, Trevoux (FR)

(73) Assignee: Graham Packaging Company, L.P., Lancaster, PA (US)

(21) Appl. No.: 15/691,051

(22) Filed: Aug. 30, 2017

Related U.S. Application Data
(63) Continuation of application No. PCT/IB2015/000505, filed on Mar. 9, 2015.

(51) Int. Cl. B29C 49/20; B29C 49/48; B29C 49/72

(52) U.S. Cl. CPC B29C 49/20; B29C 49/04; B29C 49/72; B29C 49/4823

(57) ABSTRACT

Method to manufacture a container includes disposing a first parison within a first mold assembly having a first inner surface defining a first mold chamber. The first mold assembly includes at least one first insert disposed on the first inner surface within the first mold chamber. The first parison is blow molded to form a first container body within the first mold chamber, wherein at least one first portion of the first container body corresponding to the at least one first insert has a first portion temperature greater than a remaining portion of the first container body. The at least one first portion of the first container body can be contacted to at least one second portion of a second container body to attach the first and second container bodies. Assemblies, systems, and intermediate stage pre-assembly multi-chamber containers are also disclosed, as well as multi-chamber containers formed from the same.

### BACKGROUND

### Field of the Disclosed Subject Matter

The present disclosed subject matter relates to methods, assemblies, systems, and intermediate stage pre-assembly multi-chamber containers to make multi-chamber containers, as well as multi-chamber plastic containers made from the same, for example, a dual-chamber plastic container.

### Description of Related Art

Multi-chamber container containers are used for a variety of products, such as cleaning products, including, but not limited to, toilet bowl cleaners, drain cleaners, and the like. However, such multi-chamber containers can be expensive and difficult to manufacture using conventional blow molding techniques and systems. For example, conventional molding techniques generally include mold blocks of a mold assembly that are cooled to thereby cool the temperature of an object blow therein. For example, the blow molded object can be a single chamber container.

To form a multi-chamber blow molded container, a separate attachment technique is therefore required. For example, multiple blow molded containers that are individually formed and cooled can be attached using an adhesive or welding technique. However, such techniques can introduce difficulties, which can be due to deformation, uneven cooling, leakage, or other similar problems.

There remains a need for more efficient techniques to make multi-chamber containers.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, a method to manufacture a container is provided. The method includes disposing a first parison within a first mold assembly having a first inner surface defining a first mold chamber. The first mold assembly includes at least one first insert disposed on the first inner surface within the first mold chamber. The first parison can be blow molded to form a first container body within the first mold chamber, wherein at least one first portion of the first container body corresponding to the at least one first insert has a first portion temperature greater than a remaining portion of the first container body. The at least one first portion of the first container body can be contacted to at least one second portion of a second container body to attach the first container body to the second container body.

As embodied herein, the first mold assembly can include a first set of mold blocks having an open configuration and a closed configuration, the first set of mold blocks forming the mold chamber when in the closed configuration. The first set of mold blocks can be opened before disposing the first parison therein. The first set of mold blocks can be closed with the first parison disposed therein to capture the first parison. The first set of mold blocks can be opened after blow molding the first parison to allow the first container body to be removed from the first mold assembly.

For purpose of illustration and not limitation, the first set of mold blocks can have a cooling system to cool the remaining portion of the first container body to a temperature less than the first portion temperature. Additionally, the first portion temperature can be at least a melting temperature of the parison, which can be about 130-140° C. For example and not limitation, the first portion temperature can remain greater than the remaining portion of the first container body for about 30 seconds.

For example and not limitation, the at least one first insert can have a surface area less than about 5% of the first inner surface. Additionally, the at least one first insert can include a thermally insulating material. For example, the thermally insulating material comprises polytetrafluoroethylene (PTFE).

For purpose of illustration and not limitation, the first mold assembly further can include at least one first further insert having a first heat pin. At least one first further portion of the first container body can correspond to the at least one first further insert and can have a first further portion temperature different than the first portion temperature and greater than the remaining portion of the first blow-molded container body. The first heat pin can be configured to control the first further portion temperature. For example and not limitation, the first mold assembly can include a plurality of the first inserts, each first insert comprising a thermally insulating material, and the first mold assembly further can include at least one first further insert having a first heat pin.

As embodied herein, the first inner surface further can include a surface feature forming region corresponding to at least one surface feature of the first container body, the at least one surface feature configured to facilitate alignment of the first container body with the second container body. For example and not limitation, the at least one surface feature can include at least one of a protrusion, a depression, a ridge, or a plurality of ribs.

For purpose of illustration and not limitation, the first mold assembly further can include at least one first flash pocket adjacent to the first mold chamber. The first container body can include at least one first flash portion corresponding to the at least one first flash pocket. The at least one first flash portion can be trimmed from the first container body.

As embodied herein, contacting the at least one first portion of the first container body to at least one second portion of a second container body can include disposing the first container body and the second container body in a contacting station, wherein the at least one first portion of the first container body is proximate to the at least one second portion of the second container body. Positive internal pressure can be applied within the contacting station to increase a contact force between the at least one first portion and the at least one second portion.

For purpose of illustration and not limitation, a second parison can be disposed within a second mold assembly having a second inner surface defining a second mold chamber, the second mold chamber including at least one second insert disposed on the second inner surface. The second parison can be blow molded to form a second container body. The at least one second portion of the second container body can correspond to the at least one second insert has a second portion temperature greater than a remaining portion of the second container body. The at least one second portion of the second container body can be contacted to the at least one first portion of the first container body to attach the second container body to the first container body.

As embodied herein, the first portion temperature can be at least a melting temperature of the parison, which, for example and without limitation can be about 130-140° C., and the second portion temperature can be at least the melting temperature of the parison, which, for example and without limitation, can be about 130-140° C. Additionally, the first portion temperature can remain greater than the remaining portion of the first container body for about 20 seconds, and further wherein the second portion temperature remains greater than the remaining portion of the second container body for about 20 seconds.

As embodied herein, the at least one first insert can have a surface area less than about 5% of the first inner surface. Additionally, the at least one second insert can have a surface area less than about 5% of the second inner surface.

In accordance with another aspect of the disclosed subject matter, a mold assembly is provided. The mold assembly includes a set of mold blocks having an open configuration and a closed configuration. The set of mold blocks have an inner surface forming a mold chamber when in the closed configuration. At least one of the mold blocks includes at least one insert disposed on the inner surface. The at least one insert is configured to maintain at least one first portion of a first container body formed by blow molding a parison captured within the mold chamber at a first portion temperature greater than a remaining portion of the first container body to allow the first container body to be attached to a second container body by contacting the at least one first portion to at least one second portion of the second container body.

In accordance with another aspect of the disclosed subject matter, a system to make a container is provided. The system includes a first mold assembly with a first set of mold blocks having an open configuration and a closed configuration. The first set of mold blocks has a first inner surface forming a first mold chamber when in the closed configuration. At least one of the first mold blocks includes at least one first insert disposed on the first inner surface to maintain at least one first portion of a first container body formed by blow molding a first parison captured within the first mold chamber at a first portion temperature greater than a remaining portion of the first container body. At least one pressurized fluid source can be in fluid communication with the first mold chamber to blow mold the first parison into the first container body by introducing pressurized fluid to the first mold chamber. The system further includes a contacting station to contact the at least one first portion of the first container body to at least one second portion of a second container body.

As embodied herein, the contacting station can be configured to capture the first container body and the second container body to align the at least one first portion of the first container body proximate to the at least one second portion of the second container body. Additionally, the contacting station can be configured to apply positive internal pressure to increase a contact force between the at least one first portion and the at least one second portion.

For example and not limitation, a second mold assembly comprising a second set of mold blocks can have an open configuration and a closed configuration. The second set of mold blocks can have a second inner surface forming a second mold chamber when in the closed configuration. At least one of the second mold blocks can include at least one second insert disposed on the second inner surface. The at least one second insert can maintain at least one second portion of a second container body formed by blow molding a second parison captured within the second mold chamber at a second portion temperature greater than a remaining portion of the second container body. The at least one pressurized fluid source can be in fluid communication with the second mold chamber to blow mold the second parison into the second container body by introducing pressurized fluid to the second mold chamber.

For purpose of illustration and not limitation, the first mold assembly further can include at least one first flash pocket adjacent to the first mold chamber corresponding to at least one first flash portion of the first container body. The second mold assembly further can include at least one second flash pocket adjacent to the second mold chamber corresponding to at least one second flash portion of the second container body. A trimming station can trim the at least one first flash portion from the first container body and the at least one second flash portion from the second container body.

In accordance with another aspect of the disclosed subject matter, an intermediate stage pre-assembly multi-chamber container to make a multi-chamber container is provided. The intermediate stage pre-assembly multi-chamber container includes a first blow-molded container body including a first base and a first sidewall, the first blow-molded container body having a first opening defined therein, the first sidewall having at least one first portion. A second blow-molded container body includes a second base and a second sidewall, the second blow-molded container body having a second opening defined therein, the second sidewall having at least one second portion. The at least one first portion has a first portion temperature greater than a remaining portion of the first blow-molded container body to allow the first blow-molded container body to be attached to the second blow-molded container body by contacting the at least one first portion to the at least one second portion of the second blow-molded container body.

As embodied herein, a plurality of the first portions can be included. Additionally, For example and not limitation, the first blow-molded container body further can include a first further portion having a first further portion temperature. The first further portion temperature can be different than the first portion temperature and greater than the remaining portion of the first blow-molded container body.

For purpose of illustration and not limitation, the first blow-molded container body further can include at least one first surface feature to facilitate alignment of the first blow-molded container body with the second blow-molded container body. For example, the at least one first surface feature can include at least one of a first protrusion, a first depression, a first ridge, or a first plurality of ribs. Additionally, as embodied herein, the second container body can have at least one second surface feature to receive the at least one first surface feature of the first container body.

For example and not limitation, the at least one second portion can have a second portion temperature greater than a remaining portion of the second blow-molded container body.

For purpose of illustration and not limitation, the first blow-molded container body further can include at least one first flash portion. Additionally or alternatively, the second blow-molded container body further comprises at least one second flash portion.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the disclosed subject matter. Together with the description, the drawings serve to explain the principles of the disclosed subject matter.

### BRIEF DESCRIPTION OF THE DRAWINGS

FIG. 1 is a schematic diagram illustrating a representative system according to an illustrative embodiment of the disclosed subject matter.

FIG. 2A is an end view of a representative first mold block assembly, including two mold blocks in a closed configuration to form a first mold chamber according to an illustrative embodiment of the disclosed subject matter.

FIG. 2B is a front view of one of the mold blocks of the representative first mold assembly of FIG. 2A.

FIG. 2C is a front view of another one of the mold blocks of the representative first mold assembly of FIG. 2A.

FIG. 3A is an end view of a representative second mold block assembly, including two mold blocks in a closed configuration to form a second mold chamber according to an illustrative embodiment of the disclosed subject matter.

FIG. 3B is a front view of one of the mold blocks of the representative second mold assembly of FIG. 3A.

FIG. 3C is a front view of another one of the mold blocks of the representative second mold assembly of FIG. 3A.

FIG. 3D is an exploded front view of the mold block of FIG. 3C with heat pins.

FIG. 4A is an end view of a representative contacting station according to an illustrative embodiment of the disclosed subject matter.

FIG. 4B is a partial perspective view of the representative contacting station of FIG. 4A.

FIGS. 5A-C collectively present a flow chart illustrating representative methods implemented according to an illustrative embodiment of the disclosed subject matter.

FIGS. 6A, 6B, and 6C are exploded views of representative intermediate stage pre-assembly multi-chamber containers according to illustrative embodiments of the disclosed subject matter.

FIGS. 7A, 7B, and 7C are diagrams illustrating representative multi-chamber containers made from the intermediate stage pre-assemblies of FIGS. 6A, 6B, and 6C, respectively, according to illustrative embodiments of the disclosed subject matter.

### DETAILED DESCRIPTION

Reference will now be made in detail to the various exemplary embodiments of the disclosed subject matter, exemplary embodiments of which are illustrated in the accompanying drawings. The structure and corresponding method of operation of the disclosed subject matter will be described in conjunction with the detailed description of the system.

The methods, assemblies, systems, and intermediate stage pre-assembly multi-chamber containers presented herein can be used to make multi-chamber containers. The disclosed subject matter is particularly suited to make multi-chamber plastic containers, for example, a dual-chamber plastic container.

In accordance with an aspect of the disclosed subject matter, a method to manufacture a multi-chamber container is disclosed. The method includes disposing a first parison within a first mold assembly having a first inner surface defining a first mold chamber. The first mold assembly includes at least one first insert disposed on the first inner surface within the first mold chamber. Any suitable technique can be used with the first parison to form a first container body within the first mold chamber, including and without limitation blow molding, injection molding, bi-injection molding, rotational molding, injection stretch blow molding, wherein at least one first portion of the first container body corresponding to the at least one first insert can have a first portion temperature greater than a remaining portion of the first container body. The at least one first portion of the first container body can be contacted to at least one second portion of a second container body to attach the first container body to the second container body.

In accordance with another aspect of the disclosed subject matter, a mold assembly is provided. The mold assembly includes a set of mold blocks having an open configuration and a closed configuration. The set of mold blocks has an inner surface forming a mold chamber when in the closed configuration. The mold assembly includes at least one insert disposed on the inner surface of at least one of the mold blocks to maintain at least one first portion of a first container body formed by blow molding a parison captured within the mold chamber at a first portion temperature greater than a remaining portion of the first container body to allow the first container body to be attached to a second container body by contacting the at least one first portion to at least one second portion of the second container body.

In accordance with another aspect of the disclosed subject matter, a system to make a container is provided. The system includes a first mold assembly with a first set of mold blocks having an open configuration and a closed configuration. The first set of mold blocks has a first inner surface forming a first mold chamber when in the closed configuration. At least one of the first mold blocks includes at least one first insert disposed on the first inner surface to maintain at least one first portion of a first container body formed by blow molding a first parison captured within the first mold chamber at a first portion temperature greater than a remaining portion of the first container body. At least one pressurized fluid source can be in fluid communication with the first mold chamber to blow mold the first parison into the first container body by introducing pressurized fluid to the first mold chamber. The system further includes a contacting station to contact the at least one first portion of the first container body to at least one second portion of a second container body.

In accordance with another aspect of the disclosed subject matter, an intermediate stage pre-assembly multi-chamber container to make a multi-chamber container is provided. The intermediate stage pre-assembly multi-chamber container includes a first blow-molded container body including a first base and a first sidewall, the first blow-molded container body having a first opening defined therein, the first sidewall having at least one first portion. A second blow-molded container body includes a second base and a second sidewall, the second blow-molded container body having a second opening defined therein, the second sidewall having at least one second portion. The at least one first portion has a first portion temperature greater than a remaining portion of the first blow-molded container body to allow the first blow-molded container body to be attached to the second blow-molded container body by contacting the at least one first portion to the at least one second portion of the second blow-molded container body.

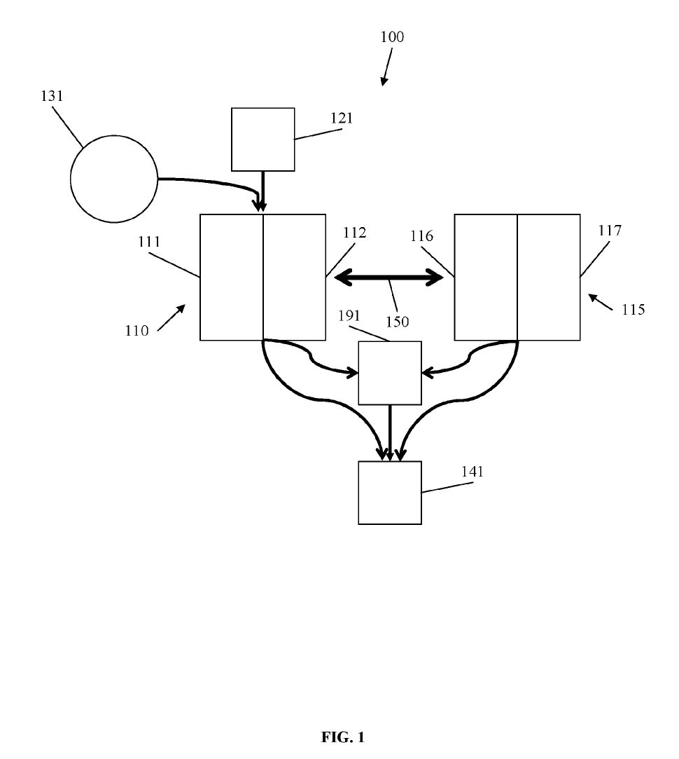

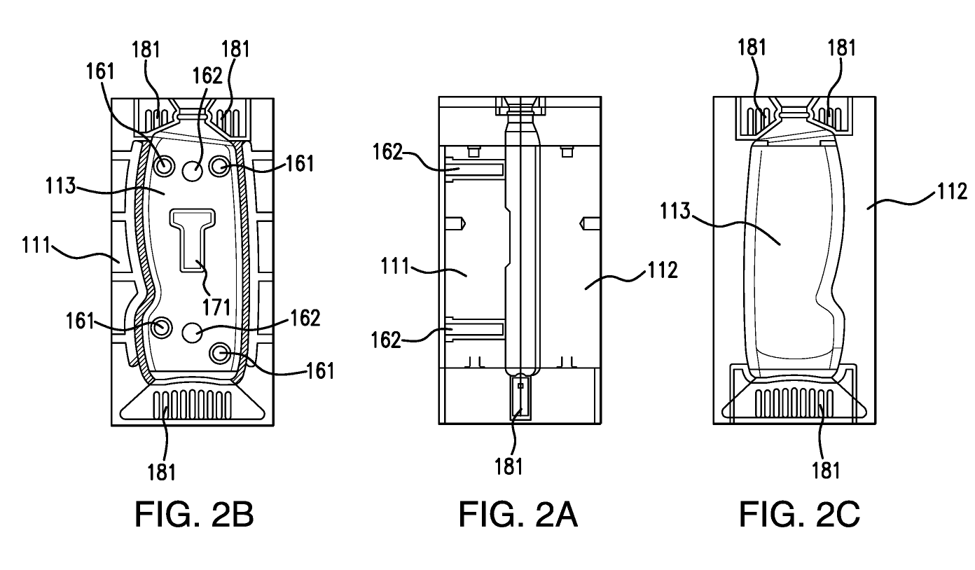

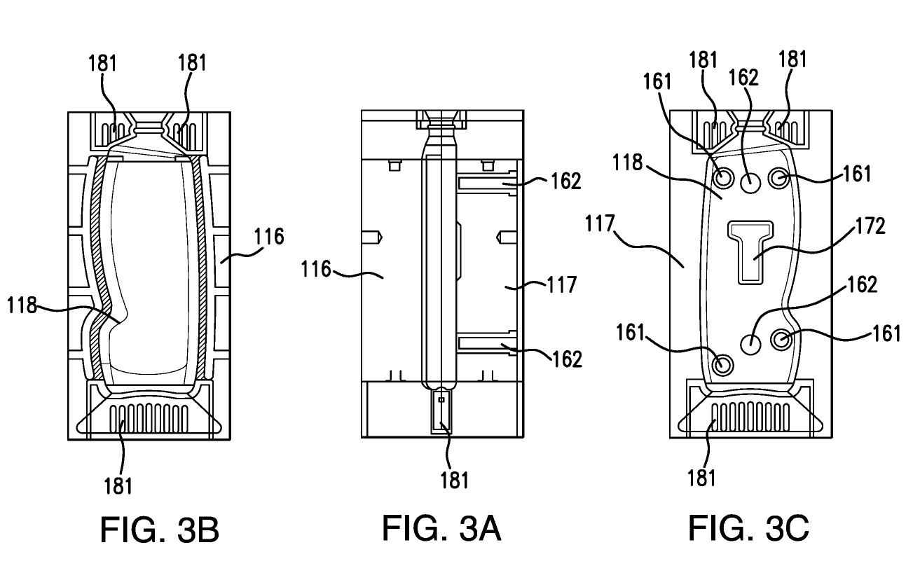

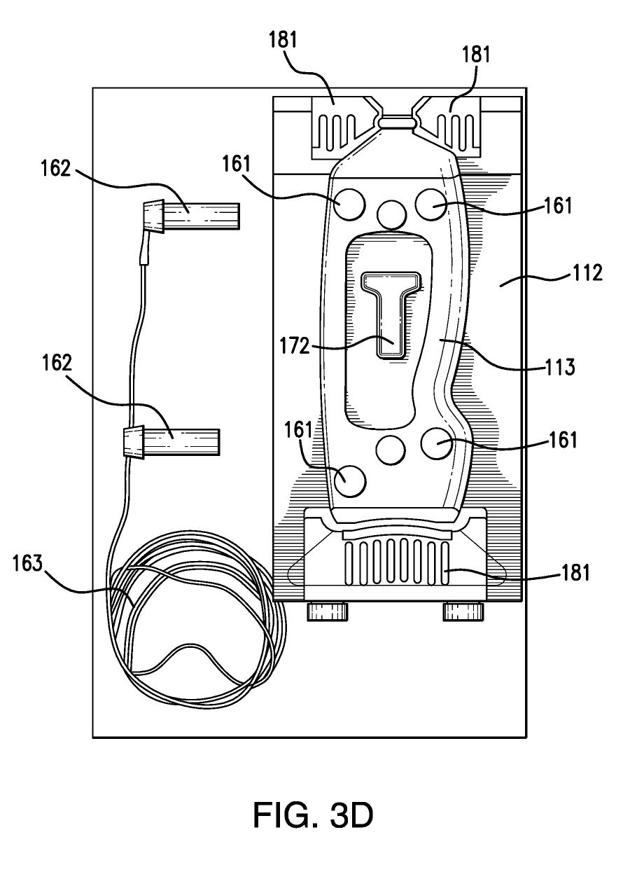

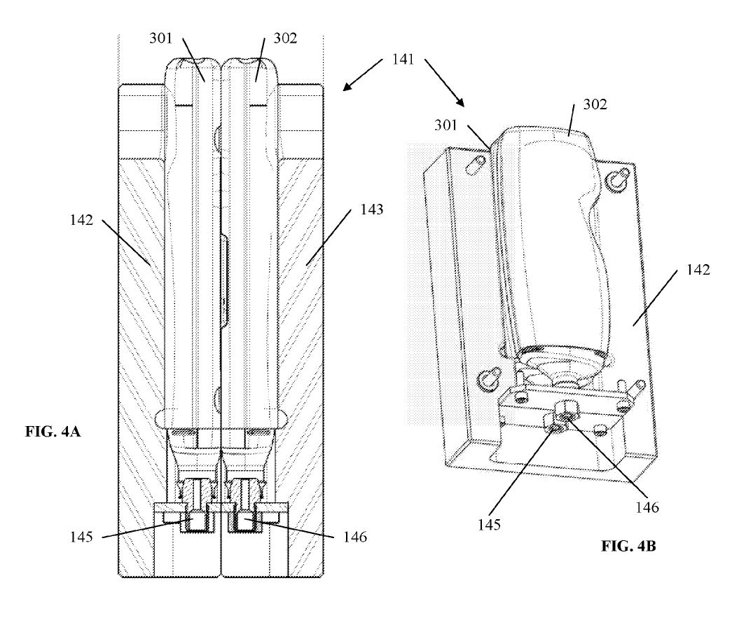

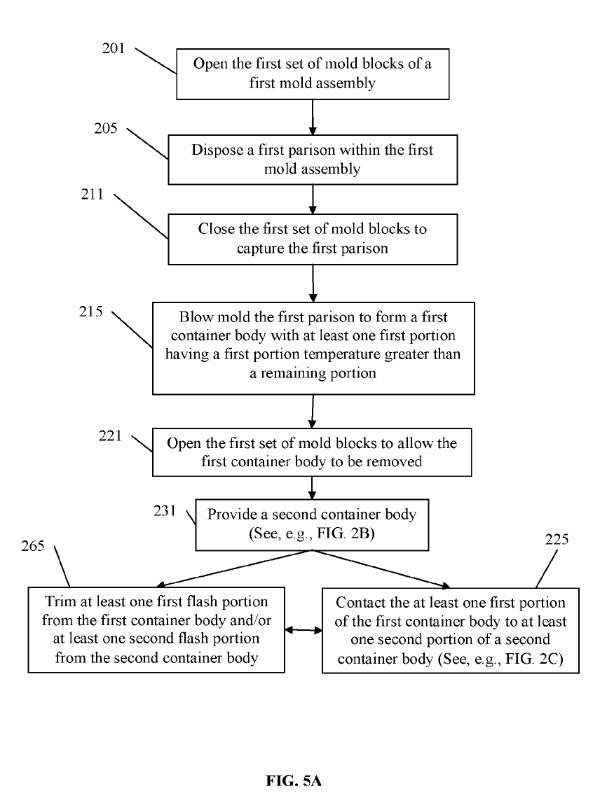

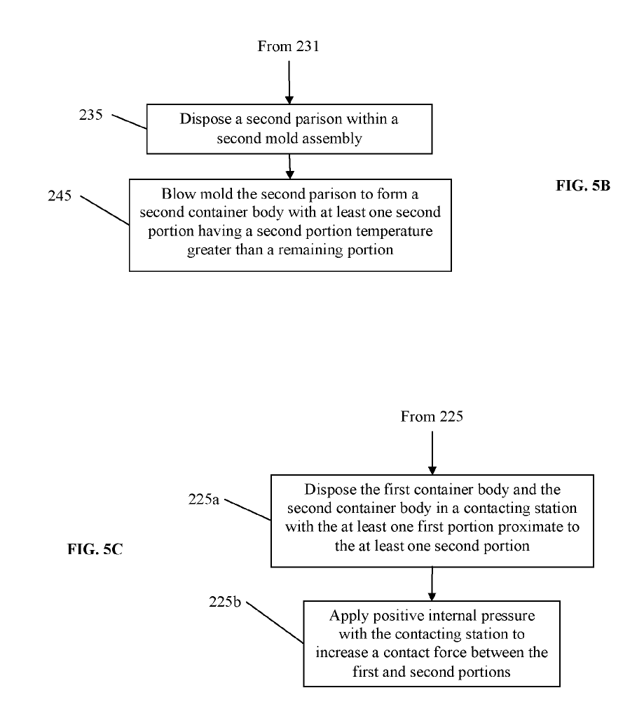

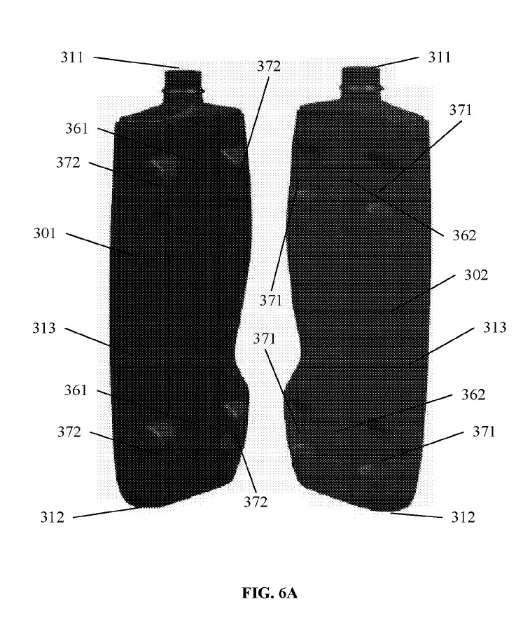

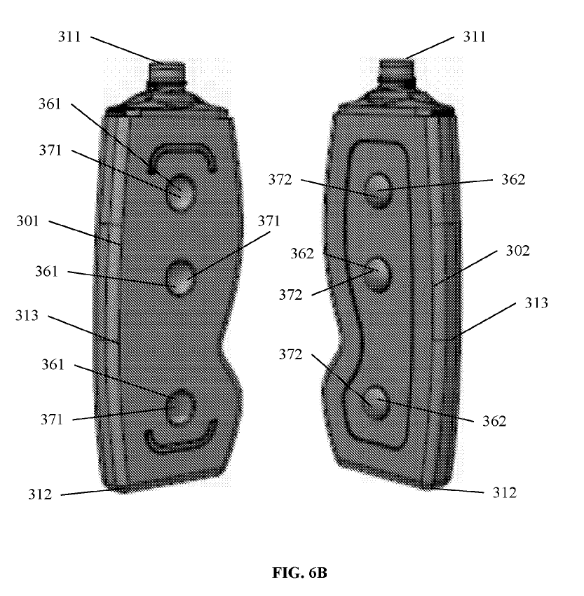

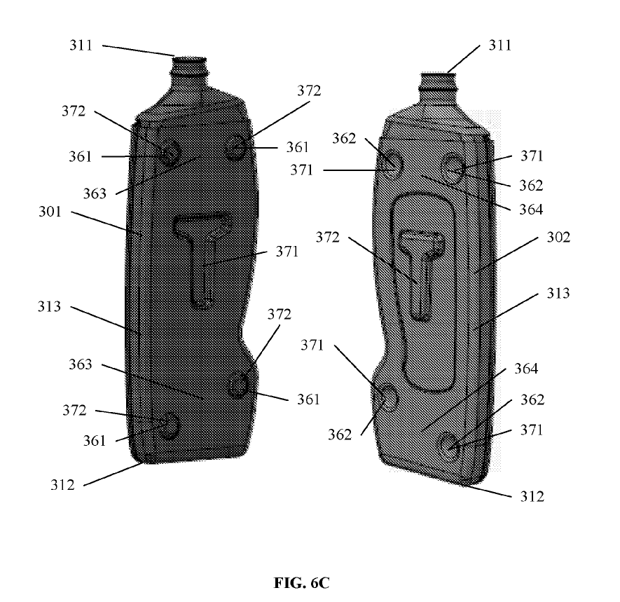

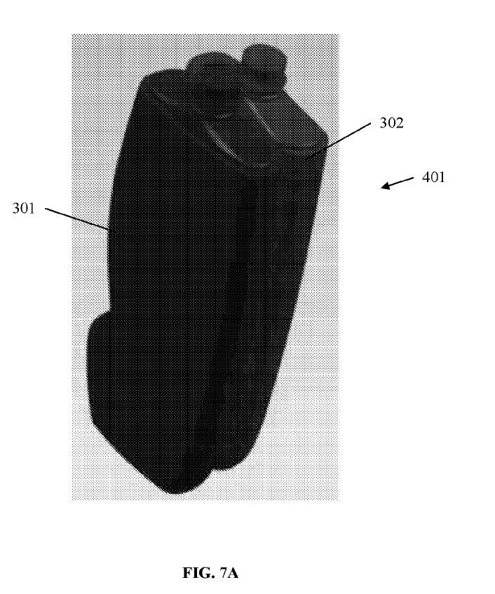

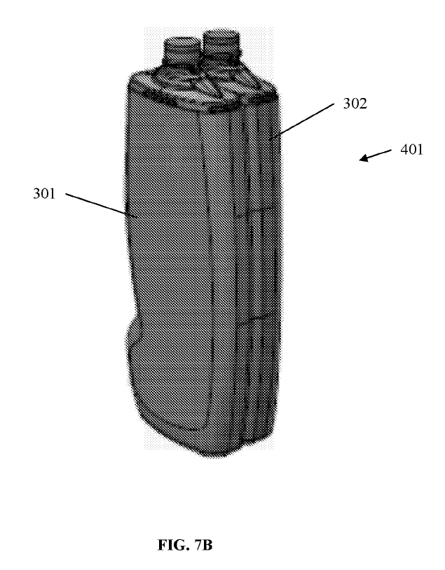

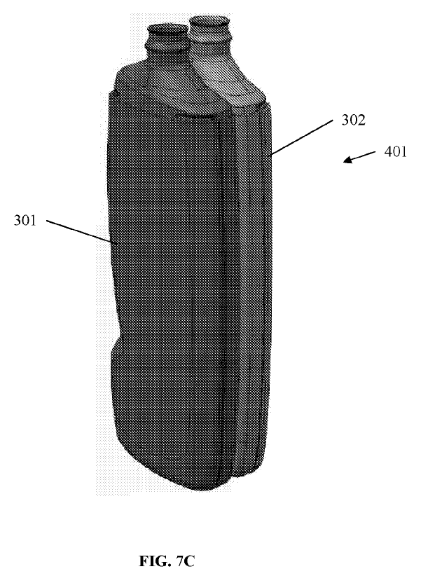

The accompanying figures, where like reference numerals refer to identical or functionally similar elements throughout the separate views, serve to further illustrate various embodiments and to explain various principles and advantages all in accordance with the disclosed subject matter. For purpose of explanation and illustration, and not limitation, an exemplary embodiment of a representative system to make a multi-chamber container in accordance with the disclosed subject matter are shown in FIG. 1. A representative first mold block assembly, including two mold blocks, in accordance with the disclosed subject matter is shown FIGS. 2A-C. A representative second mold block assembly, including two mold blocks and heat pins, in accordance with the disclosed subject matter is shown FIGS. 3A-D. A representative contacting station in accordance with the disclosed subject matter is shown FIGS. 4A-B. A flow chart illustrating representative methods implemented in accordance with the disclosed subject matter is shown collectively in FIGS. 5A-C. Exploded views of representative intermediate stage pre-assembly multi-chamber containers in accordance with the disclosed subject matter are shown in FIGS. 6A-C, and diagrams illustrating representative multi-chamber containers made from the intermediate stage pre-assemblies of FIGS. 6A-C, respectively, are shown in FIGS. 7A, 7B, and 7C. For purpose of illustration and not limitation, the methods, systems, mold assemblies, and intermediate stage pre-assembly multi-chamber containers are described in conjunction with each other.

The methods, systems, mold assemblies, and intermediate stage pre-assembly multi-chamber containers are suitable for use with a wide variety of containers. However, for purpose of understanding, reference can be made to a dual-chamber plastic container. For purpose of illustration and not limitation, the containers described herein can be formed from any material suitable for molding, including, but not limited to, plastics and other polymers. For example, the disclosed subject matter can be suited for making blow-molded containers.

In the exemplary embodiment shown in FIG. 1, a system to manufacture a container generally includes a first mold assembly 110 comprising a first set of mold blocks 111, 112. The mold blocks 111, 112 have an open configuration and a closed configuration. As depicted in FIGS. 2A-C and described below, the first set of mold blocks 111, 112 have a first inner surface 113 forming a first mold chamber when in the closed configuration. Additionally, the first mold assembly includes at least one first insert 161 disposed on the first inner surface 113 within the first mold chamber. Each first insert 161 maintains at least one first portion of a first container body 301 formed by blow molding a first parison captured within the first mold chamber at a first portion temperature greater than a remaining portion of the first container body, as discussed herein.

Referring again to FIG. 1, the first mold assembly 110 can be made of any suitable material. For purpose of illustration and not limitation, the first mold assembly can be made from a material configured to not adhere to the parison, which can be for example and as embodied herein, a metal, such as aluminum or steel. Additionally, the mold blocks 111, 112 can have any suitable size. For example and not limitation, the mold blocks 111, 112 can have a width, length, and depth suitably larger than the width, length, and depth of the first container body. For purpose of illustration and not limitation, the first mold assembly 110 can be movable along a path 150, as in a shuttle-type molding system. Examples of suitable shuttle-type molding systems include, but are not limited to, commonly assigned U.S. Pat. No. 8,506,875, titled “Single-Sided Shuttle-Type Blow Molding Method,” filed Oct. 6, 2010, U.S. Pat. No. 7,833,006, title “Single-Sided Shuttle-Type Blow Molding Apparatus,” filed Jul. 26, 2006, U.S. Pat. No. 6,730,257, titled “Shuttle-Type Blow Molding Method and Apparatus,” filed Feb. 12, 2001, U.S. Pat. No. 6,893,602, titled “Shuttle-Type Blow Molding Method and Apparatus,” filed Mar. 25, 2004, and U.S. Pat. No. 6,471,907, titled “Shuttle-Type Blow Molding Method and Apparatus,” filed Dec. 14, 2000, the disclosures of which are incorporated by reference herein in their entirety. Additionally or alternatively, the mold assembly 110 can be included in a wheel-type molding system. Examples of suitable wheel-type molding systems include commonly assigned U.S. Pat. No. 5,645,870, titled “Blow Molding Apparatus Having a Cylindrical Hub,” filed Aug. 12, 1995, U.S. Pat. No. 6,709,261, titled “Multi-Parison/Dual Cavity Wheel Blowmolds,” filed Mar. 23, 2001, U.S. Pat. No. 6,884,383, titled “Blow-Mold Wheel Speed-Up Package,” filed May 1, 2003, U.S. Pat. No. 7,316,799, titled “Blow-Mold Wheel Speed-Up Package,” filed Apr. 11, 2005, and U.S. Pat. No. 6,896,507, titled “Mold Design with Improved Cooling,” filed May 1, 2003, the disclosures of which are incorporated by reference herein in their entirety.

FIGS. 2A-C show a representative first mold block assembly, including two mold blocks, in accordance with the disclosed subject matter. For purpose of illustration and not limitation, the first insert(s) 161 can be any suitable material. For example and not limitation, the first insert(s) 161 can include a first thermally insulating material. Additionally or alternatively, the first inserts 161 can include a first thermally conductive material. For example, the first insert(s) 161 can include but are not limited to tin, aluminum, plastic, polymer, or polytetrafluoroethylene (PTFE).

Additionally, the first mold assembly 110 further can include at least one first further insert 162 including a first heat pin configured to control a first further portion temperature. At least one first further portion of the first container body corresponding to the at least one first further insert 162 can have a first further portion temperature different than the first portion temperature and greater than the remaining portion of the first blow-molded container body. For example and not limitation, there can be a plurality of the first inserts 161 and at least one first further insert 162 including a first heat pin. Some first inserts 161 can include a thermally insulating material, and at least one of the first inserts 162 can include a heat pin. Additionally or alternatively, referring to FIGS. 3C-D, the second mold assembly 115 further can include at least one second further insert 162 including a second heat pin configured to control a second further portion temperature, similar to the first further portions 162. The first (or second) heat pins can be connected by wires 163 to any appropriate controller to control the temperature. For example and not limitation, appropriate controllers can include a power supply, a computer, an integrated circuit, a thermostat or any other suitable temperature controller. The first (or second) further inserts 162 can be any suitable material, including, but not limited to, the suitable materials described above regarding the first inserts 161.

As embodied herein, the first inserts 161 and first further inserts 162 can have any suitable size. For example and not limitation, the first inserts 161 and/or the first further inserts each can have a surface area less than about 5% of the first inner surface. For purpose of illustration and not limitation, the surface area can be configured as appropriate, for example based on the materials, thicknesses and number of inserts, to prevent or inhibit joined containers from separating during a drop test and to reduce or minimize the temperature of the insert and/or prevent or inhibit the parison from adhering to the inserts. Additionally, and as embodied herein, the first inserts 161 and first further inserts 162 can have any suitable shape, including, but not limited to, circular surface area, square surface area, or rectangular surface area. Moreover, as embodied herein, there can be any suitable number and arrangement of first inserts 161 and/or first further inserts 162. For example and not limitation, there can be a single first insert 161. Alternatively, there can be a plurality of first inserts 161 arranged in any suitable arrangement. For purpose of illustration, as embodied herein, there can be four first inserts 161, and the first inserts 161 can generally be arranged at the top left, top right, bottom left, and bottom right of the inner surface 113. Additionally or alternatively, there can be a single first further insert 162, or there can be a plurality of first further inserts 162 arranged in any suitable arrangement. For purpose of illustration, as embodied herein, there can be two first further inserts 162, and the first further inserts 162 can generally be arranged at the top center and bottom center of the inner surface 113.

For purpose of illustration and not limitation, the first inner surface 113 that defines the first mold chamber can further include a surface feature forming region 171, 172 corresponding to at least one first surface feature of the first container body 301, as discussed herein. For example and not limitation, the first surface feature(s) can include at least one of a first protrusion, a first depression, a first ridge, or a first plurality of ribs. A protrusion 171 in the first inner surface 113 thus can form a corresponding depression in the first container body 301. Additionally or alternatively, a depression 172 in the first inner surface 113 can correspond to a protrusion in the first container body 301. The surface features can facilitate alignment of the first container body 301 with the second container body 302, as discussed herein. Likewise, the second container body 302 can be provided with a second surface feature to mate with the first surface feature of the first container body 301 for further alignment of the two container bodies 301, 302 together. For example and not limitation, referring to FIGS. 3A-D, a depression 172 in the second inner surface 118 can correspond to a protrusion in the second container body 302. Additionally or alternatively, a protrusion 171 in the second inner surface 118 thus can form a corresponding depression in the second container body 302. For example and not limitation, the second container body 302 can have at least one second surface feature to receive the at least one first surface feature of the first container body 301, as described herein.

Referring again to FIG. 1, at least one pressurized fluid source 131 can be in fluid communication with the first mold chamber to blow mold the first container body 301 by introducing pressurized fluid to the first mold chamber. The exemplary system herein further includes a contacting station 141 to contact the at least one first portion of the first container body 301 to at least one second portion of a second container body 302.

As embodied herein, the first set of mold blocks 116, 117 can have a cooling system to cool the remaining portion of the first container body 301 to a temperature less than the first portion temperature. For purpose of illustration and not limitation, an extruder 121 can extrude the first parison, at a temperature between about 190-210° C., and as embodied herein the temperature can be about 200° C. The first set of mold blocks 116, 117 can have a cooling temperature less than the temperature of the first parison. For example, the cooling temperature can be 8-12° C. The parison from the extruder 121 can be captured in the mold blocks 116, 117 and blow molded to form a first container body, as discussed herein. The cooled mold blocks 116, 117 can cool the temperature of the remaining portion of the first container body that does not correspond to the first insert(s) 161 or first further insert(s) 162. For example, the first container body 301 can be cooled to a temperature of 40-60° C.

As embodied herein, referring also to FIGS. 4A-B, the contacting station 141 can capture the first container body 301 and the second container body 302 with the at least one first portion of the first container body proximate to and aligned with the at least one second portion of the second container body. The contacting station 141 can apply positive internal pressure to increase a contact force between the at least one first portion and the at least one second portion. For purpose of illustration and not limitation, the contacting station 141 can have one or more inlets 145, 146. Pressurized fluid can be introduced though inlet(s) 145, 146 to apply positive internal pressure within the cavity of the first container body 301 and/or the cavity of the second container body 302, which can result in increased contact force between the first portion of the first container body 301 and the second portion of the second container body 302. The pressurized fluid can be supplied by the pressurized fluid source 131 or a separate pressurized fluid source. The positive internal pressure can be any suitable pressure applied for any suitable amount of time, which, for example and not limitation, can be between about 0.5 bar to 1.5 bar of pressure for between about 2 seconds to 5 seconds, and as embodied herein, can be 1 bar of pressure for 2 seconds.

Additionally, referring again to FIG. 1, a second mold assembly 115 can be provided. The second mold assembly 110 can be made of any suitable material, including, but not limited to, the materials discussed above regarding the first mold assembly 110. Additionally, the second set of mold blocks 116, 117 can have any suitable size. For example and not limitation, the mold blocks 116, 117 can have a width, length, and depth suitably larger than the width, length, and depth of the first container body. For example and not limitation, the second mold assembly 115 and the first mold assembly 110 can be movable along a path 150, for example as in a shuttle-type molding system or wheel-type molding system, as described above. As such, the second mold assembly 115 can also interact with the extruder 121 to capture a second parison and the pressurized fluid source 131 to blow mold the second parison into the second container body 302 as described above regarding the first mold assembly 110. Additionally or alternatively, a second extruder and/or second pressurized fluid source associated with the second mold assembly 115 can be provided. The second mold assembly 115 can include a second set of mold blocks 116, 117 having an open configuration and a closed configuration. The second set of mold blocks 116, 117 can have a second inner surface 118 forming a second mold chamber when in the closed configuration. At least one of the second mold blocks can also include at least one second insert 161 disposed on the second inner surface 11. The second insert(s) 161 can maintain at least one second portion of the second container body 302 formed by blow molding a second parison captured within the second mold chamber at a second portion temperature greater than a remaining portion of the second container body 302. Additionally, the second mold assembly can include at least one second further insert 162 including a second heat pin, similar to the first further insert 162 described above.

For purpose of illustration and not limitation, referring again to FIGS. 2A-C, the first mold assembly 110 can also include at least one first flash pocket 181 adjacent to the first mold chamber corresponding to at least one first flash portion of the first container body 301. Additionally or alternatively, referring also to FIGS. 3A-D, the second mold assembly 115 can further include at least one second flash pocket 181 adjacent to the second mold chamber corresponding to at least one second flash portion of the second container body 302. The system can also include comprising a trimming station 191 configured to trim the at least one first flash portion from the first container body 301 and the at least one second flash portion from the second container body 302. The trimming station 191 can trim the flash portion(s) using any suitable technique, including, but not limited to, a blade, a hot wire or a laser.

FIGS. 5A-C are flow charts illustrating representative methods to manufacture a container according to an illustrative embodiment of the disclosed subject matter. The exemplary methods of FIGS. 5A-C, for purpose of illustration and not limitation, are discussed with reference to the exemplary system of FIG. 1 and mold assemblies of FIGS. 2A-C and 3A-D. Referring to FIG. 5A, at 205, a first parison is disposed within a first mold assembly 110 having a first inner surface 113 defining a first mold chamber. The first mold assembly includes at least one first insert 161 disposed on the first inner surface 113 within the first mold chamber, as described above.

At 215, the first parison is blow molded to form a first container body 301 within the first mold chamber. At least one first portion of the first container body 301 corresponds to the at least one first insert 161. The first portions have a first portion temperature greater than a remaining portion of the first container body 301.

For purpose of illustration and not limitation, at 231, a second container body 302 can be provided, for example, as discussed further below regarding FIG. 2B. At 225, the first portion(s) of the first container body 301 can be contacted to at least one second portion of a second container body 302 to attach the first container body 301 to the second container body 302.

As embodied herein, the first mold assembly can include a first set of mold blocks 111, 112 having an open configuration and a closed configuration. The first set of mold blocks 111, 112 can form the mold chamber when in the closed configuration, as described above. As such, at 211, the first set of mold blocks 111, 112 can be opened before disposing the first parison therein (205). At 211, the first set of mold blocks 111, 112 can be closed with the first parison disposed therein (205) to capture the first parison. At 221, the first set of mold blocks 111, 112 can be opened after blow molding the first parison (215) to allow the first container body 301 to be removed from the first mold assembly 110.

Additionally, the first set of mold blocks 111, 112 can have a cooling system to cool the remaining portion of the first container body 301 to a temperature less than the first portion temperature, as described herein. For purpose of illustration and not limitation, the first portion temperature can remain greater than the remaining portion of the first container body for between about 0 seconds to 10 seconds. For example and not limitation, the first portion temperature can be at least a melting temperature of the parison, which can be about 130-140° C. For purpose of illustration and not limitation, during molding, the parison can be about 200° C., the mold can be about 20° C., and the insert can be about 120-130° C. During operation, the temperature of the parison can reduce. As such, when the container is removed, the temperature of container can be between about 40-60° C., and the insert can be about 120° C. After a period of time, for example about 20 seconds at room temperature, the temperature of the insert area can reduce such that the container does not adhere to other containers. Additionally or alternatively, each first insert can have a surface area less than about 5% of the first inner surface.

For purpose of illustration and not limitation, the at least one first insert 161 can include a thermally insulating material, as described herein. For example, the thermally insulating material can be PTFE, as described herein. Additionally, the first mold assembly 110 can include at least one first further insert 162 having a first heat pin configured to control a first further portion temperature as described herein, as described herein. For example, as embodied herein, at least one first further portion of the first container body 301 can correspond to the at least one first further insert 162 and can have the first further portion temperature different than the first portion temperature and greater than the remaining portion of the first blow-molded container body. For example and not limitation, a plurality of the first inserts 161 can be included, each first insert 161 comprising a thermally insulating material such as PTFE, and first mold assembly 110 further can includes at least one first further insert 162 having a first heat pin. Furthermore, and as embodied herein, the first inner surface 113 defining the first mold chamber can further include a surface feature forming region 171, 172, as described herein.

For purpose of illustration and not limitation, referring to FIG. 2C, at 225a, contacting the first portion(s) of the first container body 301 to the second portion(s) of a second container body 302 (225) can include disposing the first container body 301 and the second container 302 body in a contacting station 141, as described herein. The first portion(s) of the first container body 301 can be proximate to the second portion(s) of the second container body 302. At 225b, positive internal pressure can be applied within the contacting station 141, as described herein, to increase a contact force between the first portion(s) and the second portion(s).

Additionally, and as embodied herein, referring to FIG. 2B, at 235, a second parison can be disposed within the second mold assembly 115, which can have a second inner surface 118 defining a second mold chamber, as described herein. The second mold chamber can include at least one second insert 161 and/or at least one second further insert 162 disposed on the second inner surface 118, as described herein. At 245, the second parison can be blow molded to form a second container body 302, as described herein. The second portion(s) and second further portion(s) of the second container body 302 can correspond to the second insert(s) 161 and the second further insert(s) 162, respectively. The second portion(s) can have a second portion temperature greater than a remaining portion of the second container body 302 and/or the second further portions can have a second further portion temperature different than the second portion temperature and greater than a remaining portion of the second container body 302, as described herein. Referring again to FIG. 2A, at 225, the at least one second portion of the second container body 302 can be contacted to the at least one first portion of the first container body 301 to attach the second container body 302 to the first container body 301, as described herein.

For purpose of illustration and not limitation, the first mold assembly can include at least one first flash pocket 181 and/or the second mold assembly can include at least one second flash pocket 181, as described herein. As such, the first container body 301 and/or the second container body 302 can have at least one first flash portion and/or at least one second flash portion, respectively, as described herein. At 265, the first and/or second flash portion(s) can be trimmed from the first container body 301 and/or the second container body 302, respectively. For example and not limitation, the trimming (265) can occur before or after contacting the first container body 301 to the second container body 302 (255).

As embodied herein, the second portion temperature can remain greater than the remaining portion of the second container body 302 for about 30 seconds. Additionally, the second portion temperature can be at least the melting temperature of the parison, which can be about 130-140° C.

For purpose of illustration and not limitation, the at least one first insert 161 and/or at least one first further insert 162 can have a surface area less than about 5% of the first inner surface, as described herein. Additionally or alternatively, the at least one second insert 161 and/or at least one second further insert 162 can have a surface area less than about 5% of the second inner surface, as described herein.

FIGS. 6A-C show exploded views of representative intermediate stage pre-assembly multi-chamber containers in accordance with the disclosed subject matter. For purpose of illustration and not limitation, an intermediate stage pre-assembly multi-chamber container includes a first blow molded container body 301 and a second blow molded container body 302. The first blow-molded container body 301 includes a first base 312 and a first sidewall 313 and has a first opening 311 defined therein. The first sidewall 313 has at least one first portion 361. The second blow-molded container body 302 includes a second base 312 and a second sidewall 313 and has a second opening 311 defined therein. The second sidewall has at least one second portion 362. The at least one first portion 361 has a first portion temperature greater than a remaining portion of the first blow-molded container body 301. The first portion temperature can allow the first blow-molded container body 301 to be attached to the second blow-molded container body 302 by contacting the at least one first portion 361 to the at least one second portion 362 of the second blow-molded container body 302, as described herein. For example and not limitation, the first portion(s) 361 can correspond to first insert(s) 161 in a first mold assembly 110, as described herein.

As embodied herein, the first container body 301 can include a plurality of the first portions 361. Additionally or alternatively, the first blow-molded container body 301 further can include a first further portion 363 having a first further portion temperature. For example and not limitation, the first further portion temperature can be different than the first portion temperature and greater than the remaining portion of the first blow-molded container body 301. For example and not limitation, the first further portion(s) 363 can correspond to first insert(s) 162 having heat pins in a first mold assembly 110, as described herein.

For purpose of illustration and not limitation, the first blow-molded container body 301 further can include at least one first surface feature 371, 372. The at least one first surface feature 371, 372 can facilitate alignment of the first blow-molded container body 301 with the second blow-molded container body 302, as described herein. For example and not limitation, the first surface feature(s) can include at least one of a first protrusion 372, a first depression 371, a first ridge, a first plurality of ribs, or a combination thereof. Additionally, as embodied herein, the second container body 302 can have at least one second surface feature 371, 372 to receive the at least one first surface feature 371, 372 of the first container body.

For example and not limitation, the first portions 361 (and first further portions 363) of the first blow-molded container body 301 can contact the second portion 362 (and the second further portions 364) of the second blow-molded container body 302. Additionally, the second portions 362 can have a second portion temperature greater than a remaining portion of the second blow-molded container body 302. The second portion(s) 362 can correspond to second insert(s) 161 in a second mold assembly 115, as described herein. Additionally or alternatively, the second further portions 364 can have a second further portion temperature. The second further portion temperature can be different than the second portion temperature and greater than the remaining portion of the second blow-molded container body 302. For example and not limitation, the second further portion(s) 364 can correspond to second insert(s) 162 having heat pins in a second mold assembly 115, as described herein.

Additionally, the first blow-molded container body 301 further can include at least one first flash portion. Additionally or alternatively, the second blow-molded container body 302 further can include at least one second flash portion. The first and second flash portions can correspond to first and second flash pockets 181 in the first mold assembly 110 and the second mold assembly 115, respectively.

FIGS. 7A-C show exemplary embodiments of multi-chamber containers in accordance with the disclosed subject matter. Referring to FIG. 7A, the multi-chamber container 401 can correspond to the first container body 301 and second container body 302 depicted in FIG. 6A. For purpose of illustration and not limitation, the protrusions 372 of the first container body 301 can be aligned with the depressions 371 of the second container body 302. As such, the first portions 361 can be contacted to the second portions 362 while the first portion temperature and/or the second portion temperature is greater than the melting temperature of the parison, which as embodied herein can be about 130-140° C., to attach the first container body 301 to the second container body 302.

Referring to FIG. 7B, the multi-chamber container 401 can correspond to the first container body 301 and second container body 302 depicted in FIG. 6B. For purpose of illustration and not limitation, the depressions 371 of the first container body 301 can be aligned with the protrusions 372 of the second container body 302. As such, the first portions 361 can be contacted to the second portions 362 while the first portion temperature and/or the second portion temperature is greater than the a melting temperature of the parison, which as embodied herein can be about 130-140° C., to attach the first container body 301 to the second container body 302. For example and not limitation, as depicted in FIG. 6B, the first portions 361 can coincide with the depressions 371 of the first container body 301, and the second portions 362 can coincide with the protrusions 372 of the second container body 302.

Referring to FIG. 7C, the multi-chamber container 401 can correspond to the first container body 301 and second container body 302 depicted in FIG. 6C. For purpose of illustration and not limitation, the depression 371 and protrusions 372 of the first container body 301 can be aligned with the corresponding protrusion 372 and depressions 371 of the second container body 302. As such, the first portions 361 and first further portions 363 can be contacted to the second portions 362 and second further portions 364 while at least one of the first portion temperature, the second portion temperature, the first further portion temperature, or the second further portion temperature is greater than the melting temperature of the parison, which as embodied herein can be about 130-140° C., to attach the first container body 301 to the second container body 302. For example and not limitation, as depicted in FIG. 6C, the first portions 361 can coincide with the protrusions 372 of the first container body 301, and the second portions 362 can coincide with the depressions 371 of the second container body 302.

In addition to the specific embodiments claimed below, the disclosed subject matter is also directed to other embodiments having any other possible combination of the dependent features claimed below and those disclosed above. As such, the particular features disclosed herein can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

What is claimed is:

1. A method to manufacture a multi-chamber container, comprising:
disposing a first parison within a first mold assembly having a first inner surface defining a first mold chamber, the first mold assembly including at least one first insert disposed on the first inner surface within the first mold chamber;
blow molding the first parison to form a first container body within the first mold chamber, wherein at least one first portion of the first container body corresponding to the at least one first insert has a first portion temperature greater than a remaining portion of the first container body; and
contacting the at least one first portion of the first container body to at least one second portion of a second container body to attach the first container body to the second container body.

2. The method of claim 1, wherein the first mold assembly comprises a first set of mold blocks having an open configuration and a closed configuration, the first set of mold blocks forming the mold chamber when in the closed configuration, the method further comprising:
opening the first set of mold blocks before disposing the first parison therein;
closing the first set of mold blocks with the first parison disposed therein to capture the first parison; and
opening the first set of mold blocks after blow molding the first parison to allow the first container body to be removed from the first mold assembly.

3. The method of claim 2, wherein the first set of mold blocks has a cooling system to cool the remaining portion of the first container body to a temperature less than the first portion temperature.

4. The method of claim 1, wherein the first portion temperature is at least a melting temperature of the parison.

5. The method of claim 1, wherein the first portion temperature remains greater than the remaining portion of the first container body for about 30 seconds.

6. The method of claim 1, wherein the at least one first insert has a surface area less than about 5% of the first inner surface.

7. The method of claim 1, wherein the at least one first insert comprises a thermally insulating material.

8. The method of claim 7, wherein the thermally insulating material comprises polytetrafluoroethylene (PTFE).

9. The method of claim 1, wherein the first mold assembly further comprises at least one first further insert having a first heat pin, wherein at least one first further portion of the first container body corresponding to the at least one first further insert has a first further portion temperature different than the first portion temperature and greater than the remaining portion of the first blow-molded container body, and wherein the first heat pin is configured to control the first further portion temperature.

10. The method of claim 1, wherein the first mold assembly includes a plurality of the first inserts, each first insert comprising a thermally insulating material, and wherein the first mold assembly further comprises at least one first further insert having a first heat pin.

11. The method of claim 1, wherein the first inner surface further comprises a surface feature forming region corresponding to at least one surface feature of the first container body, the at least one surface feature configured to facilitate alignment of the first container body with the second container body.

12. The method of claim 11, wherein the at least one surface feature comprises at least one of a protrusion, a depression, a ridge, or a plurality of ribs.

13. The method of claim 1, wherein the first mold assembly further comprises at least one first flash pocket adjacent to the first mold chamber, and further wherein the first container body comprises at least one first flash portion corresponding to the at least one first flash pocket, the method further comprising trimming the at least one first flash portion from the first container body.

14. The method of claim 1, wherein contacting the at least one first portion of the first container body to at least one second portion of a second container body comprises:
disposing the first container body and the second container body in a contacting station, wherein the at least one first portion of the first container body is proximate to the at least one second portion of the second container body; and
applying positive internal pressure within the contacting station to increase a contact force between the at least one first portion and the at least one second portion.

15. The method of claim 1, further comprising:
disposing a second parison within a second mold assembly having a second inner surface defining a second mold chamber, the second mold chamber including at least one second insert disposed on the second inner surface;
blow molding the second parison to form a second container body, wherein the at least one second portion of the second container body corresponding to the at least one second insert has a second portion temperature greater than a remaining portion of the second container body; and
contacting the at least one second portion of the second container body to the at least one first portion of the first container body to attach the second container body to the first container body.

16. The method of claim 15, wherein the first portion temperature is at least a melting temperature of the parison, and wherein the second portion temperature is at least the melting temperature of the parison.

17. The method of claim 15, wherein the first portion temperature remains greater than the remaining portion of the first container body for about 30 seconds, and further wherein the second portion temperature remains greater than the remaining portion of the second container body for about 30 seconds.

18. The method of claim 1, wherein the at least one first insert has a surface area less than about 5% of the first inner surface, and further wherein the at least one second insert has a surface area less than about 5% of the second inner surface.

19. A mold assembly, comprising:
a set of mold blocks having an open configuration and a closed configuration, the set of mold blocks having an inner surface forming a mold chamber when in the closed configuration, at least one of the mold blocks including at least one insert disposed on the inner surface;
wherein the at least one insert is configured to maintain at least one first portion of a first container body formed by blow molding a parison captured within the mold chamber at a first portion temperature greater than a remaining portion of the first container body to allow the first container body to be attached to a second container body by contacting the at least one first portion to at least one second portion of the second container body.

20. The mold assembly of claim 19, wherein the set of mold blocks has a cooling system to cool the remaining portion of the first container body to a temperature less than the first portion temperature.

21. The mold assembly of claim 19, wherein the at least one insert has a surface area less than about 5% of the inner surface

22. The mold assembly of claim 19, wherein the at least one insert comprises a thermally insulating material.

23. The mold assembly of claim 22, wherein the thermally insulating material comprises polytetrafluoroethylene (PTFE).

24. The mold assembly of claim 19, further comprising at least one further insert having a heat pin, wherein the at least one further insert is configured to maintain at least one first further portion of the first container body at a first further portion temperature different than the first portion temperature and greater than the remaining portion of the first blow-molded container body, and wherein the heat pin is configured to control the first further portion temperature.

25. The mold assembly of claim 19, comprising a plurality of the inserts, each insert comprising a thermally insulating material, further comprising at least one further insert having a heat pin.

26. The mold assembly of claim 19, wherein the inner surface further comprises a surface feature forming region corresponding to at least one surface feature of the container body, the at least one surface feature configured to facilitate alignment of the first container body with the second container body.

27. The mold assembly of claim 26, wherein the at least one surface feature comprises at least one of a protrusion, a depression, a ridge, or a plurality of ribs.

28. The mold assembly of claim 19, further comprising at least one flash pocket adjacent to the mold chamber, the at least one flash pocket corresponding to at least one first flash portion of the first container body.

29. A system to make a container, comprising:
a first mold assembly comprising a first set of mold blocks having an open configuration and a closed configuration, the first set of mold blocks having a first inner surface forming a first mold chamber when in the closed configuration, at least one of the first mold blocks including at least one first insert disposed on the first inner surface, the at least one first insert configured to maintain at least one first portion of a first container body formed by blow molding a first parison captured within the first mold chamber at a first portion temperature greater than a remaining portion of the first container body;
at least one pressurized fluid source in fluid communication with the first mold chamber to blow mold the first parison into the first container body by introducing pressurized fluid to the first mold chamber; and
a contacting station configured to contact the at least one first portion of the first container body to at least one second portion of a second container body.

30. The system of claim 29, wherein the first set of mold blocks has a cooling system to cool the remaining portion of the first container body to a temperature less than the first portion temperature.

31. The system of claim 29, wherein the at least one first insert has a surface area less than about 5% of the first inner surface.

32. The system of claim 29, wherein the at least one first insert comprises a first thermally insulating material.

33. The system of claim 32, wherein the first thermally insulating material comprises polytetrafluoroethylene (PTFE).

34. The system of claim 29, wherein the first mold assembly further comprises at least one first further insert having a first heat pin, wherein the at least one first further insert is configured to maintain at least one first further portion of the first container body at a first further portion temperature different than the first portion temperature and greater than the remaining portion of the first blow-molded container body, and wherein the first heat pin is configured to control the first further portion temperature.

35. The system of claim 29, comprising a plurality of the first inserts, each first insert comprising a thermally insulating material, and wherein the first mold assembly further comprises at least one first further insert having a first heat pin.

36. The system of claim 29, wherein the first inner surface further comprises a surface feature forming region corresponding to at least one first surface feature of the first container body, the at least one first surface feature configured to facilitate alignment of the first container body with the second container body.

37. The system of claim 36, wherein the at least one first surface feature comprises at least one of a first protrusion, a first depression, a first ridge, or a first plurality of ribs.

38. The system of claim 29, wherein the contacting station is configured to capture the first container body and the second container body to align the at least one first portion of the first container body proximate to the at least one second portion of the second container body, and further wherein the contacting station is configured to apply positive internal pressure to increase a contact force between the at least one first portion and the at least one second portion.

39. The system of claim 29, further comprising a second mold assembly comprising a second set of mold blocks having an open configuration and a closed configuration, the second set of mold blocks having a second inner surface forming a second mold chamber when in the closed configuration, at least one of the second mold blocks including at least one second insert disposed on the second inner surface, the at least one second insert configured to maintain at least one second portion of a second container body formed by blow molding a second parison captured within the second mold chamber at a second portion temperature greater than a remaining portion of the second container body,
wherein the at least one pressurized fluid source is in fluid communication with the second mold chamber to blow mold the second parison into the second container body by introducing pressurized fluid to the second mold chamber.

40. The system of claim 39, wherein the first mold assembly further comprises at least one first flash pocket adjacent to the first mold chamber corresponding to at least one first flash portion of the first container body, and further wherein the second mold assembly further comprises at least one second flash pocket adjacent to the second mold chamber corresponding to at least one second flash portion of the second container body, the system further comprising a trimming station configured to trim the at least one first flash portion from the first container body and the at least one second flash portion from the second container body.

41. An intermediate stage pre-assembly multi-chamber container, comprising:
a first blow-molded container body comprising a first base and a first sidewall, the first blow molded container body having a first opening defined therein, the first sidewall having at least one first portion; and
a second blow-molded container body comprising a second base and a second sidewall, the second blow molded container body having a second opening defined therein, the second sidewall having at least one second portion,
wherein the at least one first portion has a first portion temperature greater than a remaining portion of the first blow-molded container body to allow the first blow-molded container body to be attached to the second blow-molded container body by contacting the at least one first portion to the at least one second portion of the second blow-molded container body.

42. The intermediate stage pre-assembly multi-chamber container of claim 41, comprising a plurality of the first portions.

43. The intermediate stage pre-assembly multi-chamber container of claim 41, wherein the first blow-molded container body further comprises a first further portion having a first further portion temperature, the first further portion temperature different than the first portion temperature and greater than the remaining portion of the first blow-molded container body.

44. The intermediate stage pre-assembly multi-chamber container of claim 41, wherein the first blow-molded container body further comprises at least one first surface feature the at least one first surface feature configured to facilitate alignment of the first blow-molded container body with the second blow-molded container body.

45. The intermediate stage pre-assembly multi-chamber container of claim 44, wherein the at least one first surface feature comprises at least one of a first protrusion, a first depression, a first ridge, or a first plurality of ribs.

46. The intermediate stage pre-assembly multi-chamber container of claim 44, wherein the second container body has at least one second surface feature to receive the at least one first surface feature of the first container body.

47. The intermediate stage pre-assembly multi-chamber container of claim 41, wherein the at least one second portion has a second portion temperature greater than a remaining portion of the second blow-molded container body.

48. The intermediate stage pre-assembly multi-chamber container of claim 41, wherein the first blow-molded container body further comprises at least one first flash portion, and wherein the second blow-molded container body further comprises at least one second flash portion.
